(19) United States
(12) Patent Application Publication
(10) Pub. No.: US 2008/0127042 A1
(43) Pub. Date: May 29, 2008

(54) Customizable list of application specific terms

(75) Inventors: Martha Arellano Lopez, Sammamish, WA (US); Srinivas Mandalika, Redmond, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/581,892

(22) Filed: Oct. 17, 2006

(51) Int. Cl. G06F 9/44

(52) U.S. Cl. 717/101

(57) ABSTRACT

A list of application specific terms is provided in association with a business application. Changing terms included in the list changes the terminology incorporated into user interfaces associated with the application. In one embodiment, the list of application specific terms is exposed as part of a software development kit.

### BACKGROUND

Certain business software applications, such as accounting applications, allow or enable independent software vendors (ISVs) to build extensions to the application. Some of these extensions are designed to equip the application with industry specific functionality for targeted industries such as construction, farming, medical, etc. Many of these vertical extensions use different terms for the same entities, so ISVs not only have the need to add their own functionality but also to change existing application components (e.g., the user interfaces) to incorporate the most common terminology for the relevant-industry.

The discussion above is merely provided for general background information and is not intended for use as an aid in determining the scope of the claimed subject matter.

### SUMMARY

A list of application specific terms is provided in association with a business application. Changing terms included in the list changes the terminology incorporated into user interfaces associated with the application. In one embodiment, the list of application specific terms is exposed as part of a software development kit.

This Summary is provided to introduce a selection of concepts in a simplified form that are further described below in the Detailed Description. This Summary is not intended to identify key features or essential features of the claimed subject matter, nor is it intended for use as an aid in determining the scope of the claimed subject matter. The claimed subject matter is not limited to implementations that solve any or all disadvantages noted in the background.

### BRIEF DESCRIPTION OF THE DRAWINGS

FIG. 1 is a schematic illustration of an application.

FIG. 2 is a flow chart diagram demonstrating steps associated with making a replacement determination.

FIG. 3 is a flow chart diagram demonstrating steps associated with updating a default set of terms.

FIG. 4 illustrates an example of a computing system environment.

### DETAILED DESCRIPTION

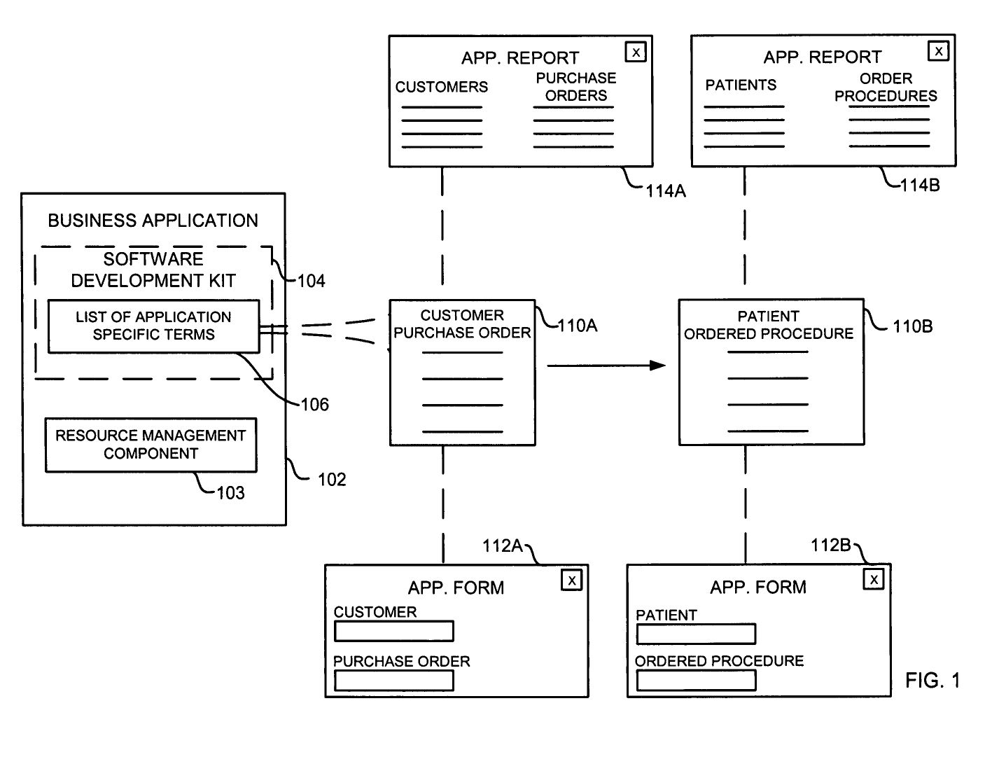

FIG. 1 is a schematic illustration of an application 102. A list 106 of application specific terms is shown as being associated with application 102. While list 106 is illustrated as being within application 102, this need not necessarily be the case. List 106 can be made accessible to application 102 from any location without departing from the scope of the present invention.

List 106 contains at least some terms that are incorporated into user interface components of application 102. For example, a given term in list 106 might be utilized to identify an object or controls within an application user interface such as, but not limited to, a form, menu, printing or report interface. List 106 is adjustable in that a new term can be substituted for an existing term. When a term in list 106 is changed, the new term is substituted within application 102 to reflect the change. In one embodiment, this substitution involves a propagation of the new term to multiple instances of the old term within a single or multiple interfaces within application 102.

Within FIG. 1, block 110A is a simplification of an example list 106. The set of terms in block 110A is illustratively a default set of terms that is incorporated into user interface components associated with application 102. As is shown, the default set includes the terms “customer” and “purchase order.” Box 112A is a simplification of an example form interface associated with application 102. Box 114A is a simplification of an example report interface associated with application 102. Consistent with the list contained in box 110A, both form 112A and report 114A incorporate the terms “customer” and “purchase order.”

Block 100B represents an updated version of the list 106 shown in box 110A. Specifically, the term “customer” has been changed to “patient,” and the term “purchase order” has been changed to “ordered procedure.” It is the updated terms that will now be incorporated into interface components associated with application 102. Accordingly, as is shown in boxes 112B and 114B, the terms “patient” and “ordered procedure” have replaced “customer” and “purchase order” in the form and the report.

In at least some currently known systems for managing resources, when user interfaces such as dialogs are developed, labels are maintained in a separate file (e.g., a .resx file) and usually called as a resource. During compilation, the resource file is combined with the more functional code in order to create a complete executable file. In many cases, all labels within a given application are handled in this manner.

In contrast, in one embodiment, a resource management component 103 is employed to search for a corresponding placeholder each time a label is retrieved. List 106 contains placeholders for some or all entity names associated with application 102 (e.g., the application includes a plurality of object entities represented within an object schema). Replacements are made when appropriate. The functionality of resource management component 103 can be implemented independently or as an extension of an existing resource management system.

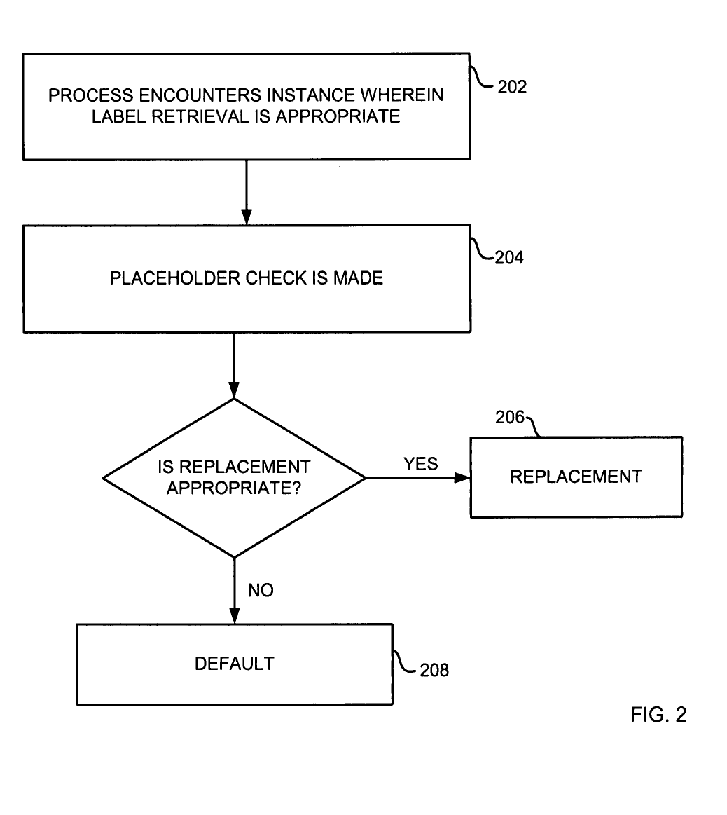

FIG. 2 is a flow chart diagram demonstrating steps associated with making a replacement determination. In accordance with block 202, a process encounters an instance wherein label retrieval is appropriate. In accordance with block 204, a check is made to determine whether replacement in conjunction with a placeholder is appropriate. If so, a replacement with the placeholder value is made. If not, a default value (if any) is retrieved. In one embodiment, the replacement value is the default value. Regardless of the exact details of implementation, one embodiment of the present invention contemplates a resource management component performing a placeholder check rather than automatically retrieving and asserting a collection of label values.

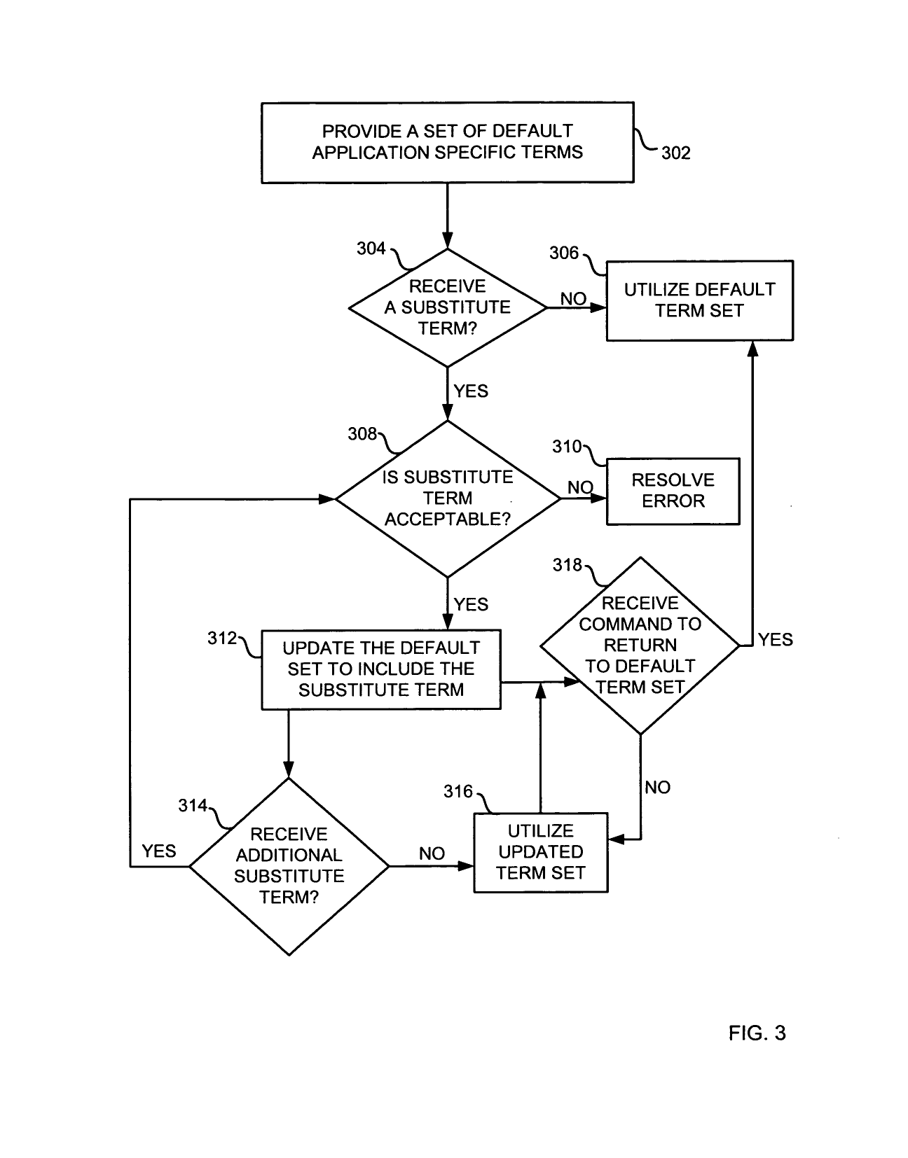

FIG. 3 is a flow chart diagram demonstrating steps associated with updating a default set of terms included within a list 106 of application specific terms as described herein. In accordance with block 302, a set of default application specific terms is provided. As is generally indicated by the “no” path extending from decision block 304, and in accordance with block 306, the default set of terms is utilized if no term substitutions are requested. In other words, the terminology utilized within the application components will reflect the default list.

As is generally indicated by the “yes” path extending from decision block 304, if a substitute term is received, a determination is made as to whether the proposed substitution is acceptable. In this regard, the system can be configured to evaluate the proposed substitution for any of a variety of criteria such as, but not limited to, length, type of characters, inclusion in a list of candidate choices, etc. If the proposed substitution does not satisfy applicable criteria, then, in accordance with block 310, steps are carried out to resolve the applicable issue so as to lead to entry of an acceptable substitute term or a termination of the substitution process. It should be noted that the candidate evaluation process reflected in blocks 308 and 310 is optional. The system could just as easily be configured to accept all (or no) proposed substitutions to the default list.

In accordance with block 312, the default set of application specific terms is updated to reflect the proposed substitute term. As is indicated by block 314, additional substitute terms may be added to the list. Following all updates, in accordance with block 316, the updated term set is utilized. In other words, the terminology utilized within the application components will reflect the updated list.

Block 318 represents another optional process. In this case, once the default list has been updated, a mechanism is employed to effectively undo whatever changes have been made. In other words, the terminology utilized within the application components will again reflect the default set of terms.

In one embodiment, as is shown in dots in FIG. 1 to demonstrate the optional nature of the configuration, list 106 is exposed as a part of a software development kit 104. Kit 104 is illustratively a development kit that enables a developer (e.g., an independent software vendor) to build an extension to application 102. The developer can customize application 102 for a particular industry by simply adjusting list 106 so as to update the terminology incorporated into various components of application 102 (e.g., various user interface components). These changes can then be installed to any machine operating application 102, for example as part of an extension or customized solution. Thus, the developer is provided with an efficient alternative to being forced either to accommodate less desirable terminology or re-build portions of application (e.g., user interfaces) to support different terminology.

In accordance with one embodiment, a user of application 102 is provided with access to the list 106 of application specific terms. The user is illustratively allowed to change all or some of the terms. In one embodiment, a user (or a developer for that matter) is provided with a tool or wizard to facilitate the process of making changes within list 106. In general, it is within the scope of the present invention for changes to be made to list 106 (by a user, a developer, automatically, or otherwise) without the list ever actually being displayed or otherwise directly presented.

The present invention contemplates the fact that any application component can be configured to incorporate a particular term or terms as reflected in list 106. In one embodiment, list 106 contains a placeholder for some or all entities (a.k.a., objects) incorporated into a user interface associated with application 102. Broader than that, however, any form, menu, report, print job, control, text box, or other application component can be configured to incorporate a list term or terms.

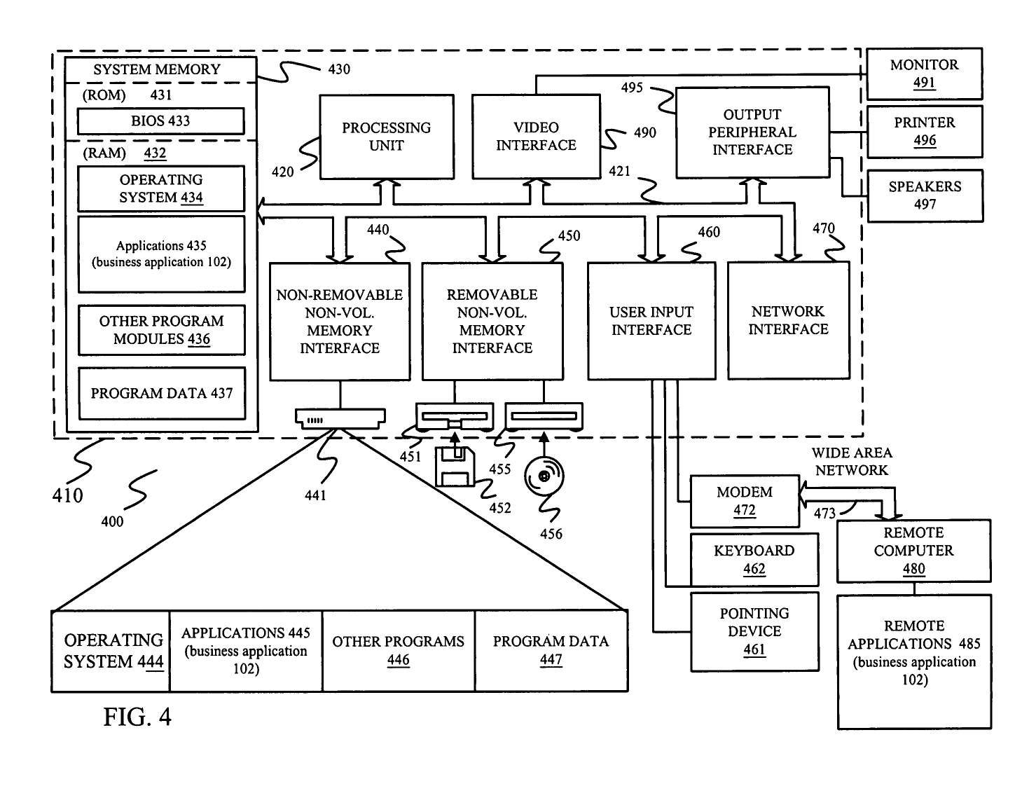

FIG. 4 illustrates an example of a suitable computing system environment 400 in which embodiments may be implemented. The computing system environment 400 is only one example of a suitable computing environment and is not intended to suggest any limitation as to the scope of use or functionality of the claimed subject matter. Neither should the computing environment 400 be interpreted as having any dependency or requirement relating to any one or combination of components illustrated in the exemplary operating environment 400.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments have been described herein in the general context of computer-executable instructions, such as program modules, being executed by a computer. Generally, program modules include routines, programs, objects, components, data structures, etc. that perform particular tasks or implement particular abstract data types. Embodiments can be practiced in distributed computing environments where tasks are performed by remote processing devices that are linked through a communications network. In a distributed computing environment, program modules can be located on both (or either) local and remote computer storage media including memory storage devices.

With reference to FIG. 4, an exemplary system for implementing some embodiments includes a general-purpose computing device in the form of a computer 410. Components of computer 410 may include, but are not limited to, a processing unit 420, a system memory 430, and a system bus 421 that couples various system components including the system memory to the processing unit 420.

Computer 410 typically includes a variety of computer readable media. Computer readable media can be any available media that can be accessed by computer 410 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436, and program data 437. As is indicated, programs 435 may include business application 102 as described above in relation to FIG. 1. This need not necessarily be the case.

The computer 410 may also include other removable/non-removable volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media discussed above and illustrated in FIG. 4, provide storage of computer readable instructions, data structures, program modules and other data for the computer 410. In FIG. 4, for example, hard disk drive 441 is illustrated as storing operating system 444, application programs 445, other program modules 446, and program data 447. Note that these components can either be the same as or different from operating system 434, application programs 435, other program modules 436, and program data 437. Operating system 444, application programs 445, other program modules 446, and program data 447 are given different numbers here to illustrate that, at a minimum, they are different copies. As is indicated, programs 445 may include business application 102 as described above in relation to FIG. 1. This need not necessarily be the case.

A user may enter commands and information into the computer 410 through input devices such as a keyboard 462 and a pointing device 461, such as a mouse, trackball or touch pad. Other input devices (not shown) may include a joystick, game pad, microphone, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. In addition to the monitor, computers may also include other peripheral output devices such as speakers 497 and printer 496, which may be connected through an output peripheral interface 495.

The computer 410 is operated in a networked environment using logical connections to one or more remote computers, such as a remote computer 480. The logical connection depicted in FIG. 4 is a wide area network (WAN) 473, but may also or instead include other networks (e.g., a local area network). Computer 410 includes a modem 472 or other means for establishing communications over the WAN 473, such as the Internet. The modem 472, which may be internal or external, may be connected to the system bus 421 via the user-input interface 460, or other appropriate mechanism. By way of example, and not limitation, programs 445 may include business application 102 as described above in relation to FIG. 1. This need not necessarily be the case.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of supporting customizable terminology within an application, the method comprising:
providing a set of entity names incorporated into an application, wherein each entity name corresponds to an object represented within an object schema associated with the application;
receiving a substitute term for a particular one of the entity names; and
incorporating in place of the particular entity name, the substitute term into a component of the application.

2. The method of claim 1, wherein incorporating into a component of the application comprises incorporating into a user interface component associated with the application.

3. The method of claim 1, further comprising incorporating the substitute term into the set of entity names such that the substitute term becomes part of the set.

4. The method of claim 1, wherein providing a set of entity names comprises providing a collective list of entity names.

5. The method of claim 1, wherein providing a set of entity names comprises providing a directory of entity names.

6. The method of claim 1, wherein providing comprises providing as part of a software development kit associated with the application.

7. The method of claim 1, wherein providing comprises providing within a software development environment configured to support enhancement of the application.

8. The method of claim 1, wherein incorporating comprises determining whether there is a replacement value associated with a label that is to be incorporated into the application.

9. The method of claim 8, wherein determining comprises utilizing a resource management component to determine.

10. The method of claim 1, further comprising evaluating the substitute term for satisfaction of a predetermined criteria.

11. A system for supporting customizable terminology within an application, the system comprising:
an application;
a list of application specific terms associated with the application; and
a resource management component configured to facilitate retrieval of a term in said list for incorporation into a component of the application.

12. The system of claim 11, further comprising a software development kit from which the list is exposed.

13. The system of claim 11, wherein the list is exposed as part of a software development kit configured to support enhancement of the application.

14. The system of claim 11, wherein the component of the application is a user interface component.

15. The system of claim 11, wherein the resource management component is configured to facilitate retrieval when it is determined that there is a replacement value associated with a label to be incorporated into an application component.

16. The system of claim 11, wherein the list of application specific terms comprises a set of entity names.

17. A development system configured to facilitate enhancement of an application, wherein the system comprises a collective list of application specific terms that are incorporated into one or more user interface components associated with the application.

18. The development system of claim 17, wherein the list is exposed to a resource management component configured to facilitate retrieval of a replacement term from the list when it is determined that a particular user interface label is associated with the replacement term.

19. The development system of claim 17, wherein the collective list of application specific terms is a directory of entity names.

20. The development system of claim 19, wherein each entity name in the directory corresponds to an object represented within an object schema associated with the application.
